(19) United States
(12) Patent Application Publication
(10) Pub. No.: US 2016/0144975 A1
(43) Pub. Date: May 26, 2016

(54) Method for Automated Calculation of the Center of Gravity and the Weight of Aircraft on the Ground

(71) Applicant: KIRIL LLIEV TOMOV, Sofia (BG)

(72) Inventor: KIRIL LLIEV TOMOV, Sofia (BG)

(21) Appl. No.: 14/549,669

(22) Filed: Nov. 21, 2014

(51) Int. Cl. B64D 43/00; G01M 1/12; G01G 19/02; B64C 25/58

(52) U.S. Cl. CPC B64D 43/00; B64C 25/58; G01M 1/125; G01G 19/028

(57) ABSTRACT

The method is to be applied by the aircraft manufacturing companies for the purpose of passenger and cargo aircraft design. The result of applying the method by aircraft manufacturers will be to increase the precision of the passenger and cargo weight calculation.

Two of the most important characteristics in aircraft design are the Centre of Gravity (CG) and the Total Aircraft Load (G) as they are directly related to its balance, stability and safety in flight. This is why it is mandatory that CG and G are calculated before every take off. The currently used calculations are based on the classic method: multiplying the weights of the passengers and the cargo by the distance to a fixed point in the aircraft, then divided to the total sum of the weights. There are software solutions and charts developed on the basis of the classic method and they are widely used by aircraft producers and airlines. However they are mainly relying on a manual data input. The presented method is based on an alternative approach, allowing for the automated calculation of fluctuations in the CG while the aircraft is being loaded. The same method could also be used to calculate the CG of an empty aircraft.

The presented method is based on automated data reception from sensors positioned in specific locations in the aircraft. This information goes directly to the cockpit onboard computer. The calculated CG and G results are then available on a cockpit display.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

The Center of Gravity (CG) and take-off weight (G) are the main characteristics of the airplane and are associated with its balancing, stability and navigability during the flight. Therefore, it is mandatory center of gravity and take-off weight to be calculated before the departure of each aircraft. Currently used methods of calculation are based on the classical scheme: multiplying the weights of passengers, baggage and cargo by their distances to a fixed point in the aircraft and the sum of the moments divided by the sum of the weights. To facilitate this calculation, the Airline Companies are using graphs, charts and computer programs that are always associated with the direct participation of a human.

### FIELD OF THE INVENTION

The method applies to the aircraft manufacturing companies which produce passenger and cargo aircrafts design. Implementation of the method will improve the performance characteristics of these aircrafts, and the effect of the implementation will reflect in the activities of the airline companies.

### BRIEF SUMMARY OF THE INVENTION

The presented method is based on an alternative approach, allowing for the automated calculation of fluctuations in the CG while the aircraft is being loaded. The same method could also be used to calculate the CG of an empty aircraft.

The presented method is based on pressure readings from the shock absorbers in the main and nose landing gear, transmitted in real time to the onboard computer in the aircraft cockpit. Therefore the aircraft Centre of gravity and the Weight are calculated while loading, and the human factor is eliminated.

### BRIEF DESCRIPTION OF THE SEVERAL VIEWS OF THE DRAWINGS

In Section 6, in the detailed description are shown FIG. 1-7, which are ancillary to the text in the exhibition. Notations in the figures correspond closely to those used in the detailed description.

FIG. 1 Center of Gravity of the aircraft

FIG. 2 Determination the CG of aircraft

FIG. 3 Calculation of the load carried by the nose gear

FIG. 4 Calculation of the load carried by the main gear

FIG. 5 Changes of the variables as a result from the aircraft's load

FIG. 6 Calculation of the shift of the nose gear

FIG. 7 Input information flow chart

### DETAILED DESCRIPTION OF THE INVENTION

### 1. Center of Gravity of the Aircraft

The Center of Gravity (CG), or the balance point, is one of the main characteristics of an aircraft and it is directly related to its balance, stability and safety of the flight.

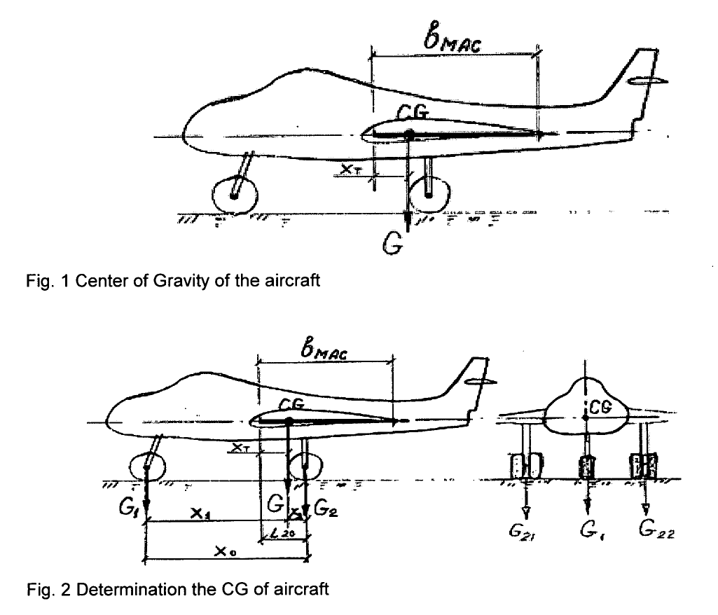

The distance from the CG to the leading edge of Mean Aerodynamic Chord (MAC) (FIG. 1) is commonly expressed as a Dercentaae of its length.

$${\overline{X}}_{T} = \frac{{X}_{T}}{{b}_{MAC}} * 100 ( \% ) , \qquad ( 1 )$$

where
X_{T} is the distance from the CG to the leading edge of MAC;
b_{MAC}—Mean Aerodynamic Chord.
Since b_{MAC} is a known and constant value for each aircraft, X_{T} is will be a variable which has to be calculated.

### 2. Variation CG of an Aircraft During Loading

The distribution of the passengers' and cargo weights to a great extent would affect the aircrafts CG and its overall balance.

To ensure the aircraft is safe to fly, the CG must fall within specified limits, established by the aircraft manufacturer.

We are looking at the classic scenario of aircraft with a tricycle landing gear. The total aircraft load is distributed over the main and nose gear as follows:

G=G₁+G₂, where

G₁ is the load carried by nose gear, and
G₂=G₂₁+G₂₂ is the load carried by the main gear.

According to FIG. 2 the distance from CG to the leading edge of the MAC equals to:

X_{T}=L₂₀−X₂,where (2)

L₂₀ is the distance from the leading edge of MAC to the main gear (as determined by the aircraft manufacturer), and
X₂ is the distance from the CG to the main gear (a variable dependent on the actual load distribution).

From system stability point of view, on the other hand,

G₁*X₁=G₂*X₂

G₁=G−G₂,

### Consequently,

$${X}_{1} ( G - {G}_{2} ) = {G}_{2} * {X}_{2} \\ {X}_{2} = \frac{{X}_{1} ( G - {G}_{2} )}{{G}_{2}} \\ {X}_{2} = {X}_{1} * \frac{{G}_{1}}{{G}_{2}} \qquad ( 3 )$$

### 3. Calculation the Values of the Variables

As shown in equation (3), the unknown values are X₁, G₁ and G₂ which have to be calculated.

### 3.1. Calculation of G₁

The aircraft weight (G) carried by the nose gear (G₁) creates pressure in shock absorber, proportional to this force.

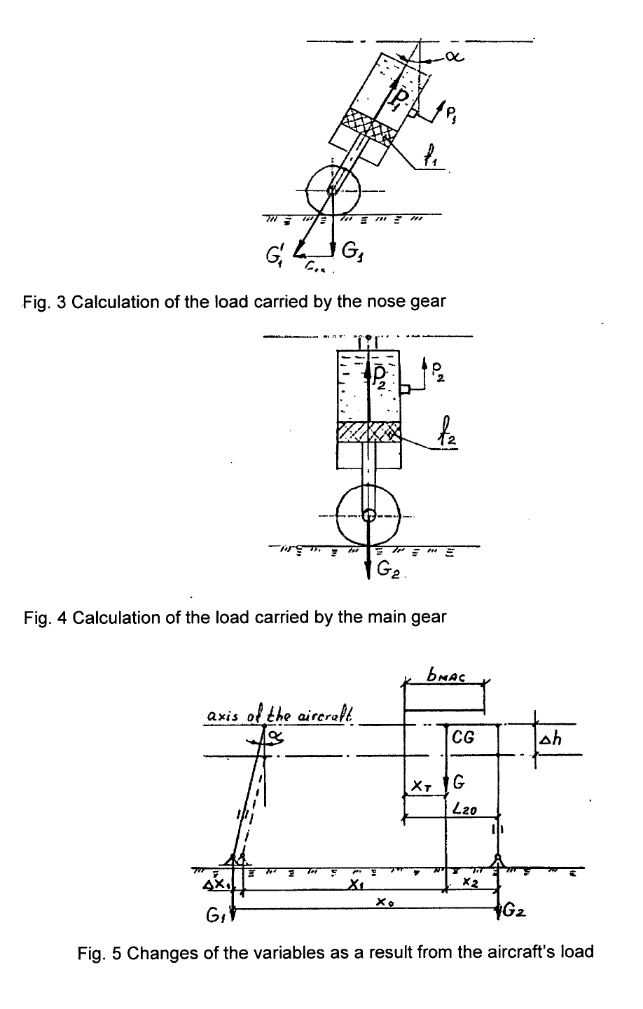

Since the nose gear is angled against the vertical axis (FIG. 3), then

G₁=\acute{G}₁*cos ∝

\acute{G}₁=P₁=p₁*f₁

G₁=p₁*f₁*cos ∝, where (4)

p₁ is the pressure in the shock absorber of the nose gear;
f₁ is the area of the shock absorber's piston;
∝ is the angle of the nose gear against the vertical axis.
All above parameters are constant but specific for each aircraft and can be provided by aircraft manufacturer.

### 3.2. Calculation of G₂

The aircraft weight (G) carried by the main gear (G₂) creates pressure in shock absorber (FIG. 4).

Therefore

G₂=P₂, where

P₂=P₂₁+P₂₂, where
P₂₁=p₂₁*f₂ is the force into the left main gear
P₂₂=p₂₂*f₂ is the force into the right main gear

G₂=f₂(p₂₁+p₂₂), (5)

p₂₁—The pressure of the shock absorber into the left main gear
p₂₂—The pressure of the shock absorber into the right main gear
f₂—The area of the shock absorber's piston of the main gear

Consequently, if the value of the pressure into the shock absorber is known (or measured), the load carried by the main landing gear (G₂) would be known as well.

3.3. Calculation of X₁ and X₂ (FIG. 5)
The aircraft's axis shifts down to Δh as a result of the aircrafts' load.
Assuming that the shock absorbers of the main and nose gear are loaded simultaneously, then the nose gear would shift to ΔX₁.
(that is true because both nose and main gear are locked to the aircraft, but the main gear must remain perpendicular to the plane of the aircraft axis, whereas the nose gear is angled against the vertical axis is angled against the vertical axis)

As shown in FIG. 5

$$\begin{matrix}{X}_{1} + {X}_{2} + Δ {X}_{1} = {X}_{0} \\ {X}_{1} + {X}_{1} * \frac{{G}_{1}}{{G}_{2}} + Δ {X}_{1} = {X}_{0} \\ {X}_{1} ( 1 + \frac{{G}_{1}}{{G}_{2}} ) = {X}_{0} - Δ {X}_{1} \\ {X}_{1} = \frac{( {X}_{0} - Δ {X}_{1} ) * {G}_{2}}{{G}_{2} + {G}_{1}} = \frac{{G}_{2}}{G} ( {X}_{0} - Δ {X}_{1} ) & ( 6 ) \\ {X}_{2} = \frac{{G}_{1}}{G} ( {X}_{0} - Δ {X}_{1} ) where & ( 7 )\end{matrix}$$

ΔX₁ is the shift of the nose gear;
X₀ is the wheel base of a vacant, but fully equipped aircraft.

### 3.4. Calculation of ΔX₁

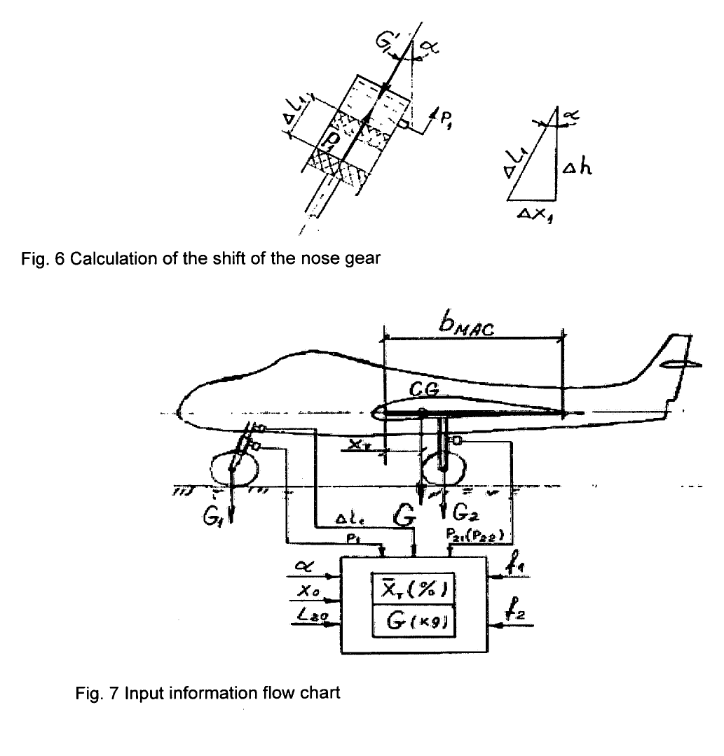

As shown in FIG. 6,

ΔX₁=Δl₁ sin α,where (8)

Δl₁ is the movement of the nose gear's shock absorbent piston;
Δh is the shift of the aircraft's axis, resulting from the aircraft load
∝ is the angle of the nose gear measured from the vertical axis.

### 4. Calculating the CG

4.1. Equation to calculate the X_{T} and G

Using the previous equations can be calculated X_{T} and G:

$$\begin{matrix} {X}_{T} = {L}_{20} - {X}_{1} \frac{{G}_{1}}{{G}_{2}} \\ {X}_{T} = {L}_{20} - \frac{{G}_{1}}{G} ( {X}_{0} - Δ {X}_{1} ) \\ {\overline{X}}_{T} = [ {L}_{20} - \frac{{p}_{1} * {f}_{1} * cos ∝}{{p}_{1} * {f}_{1} * cos ∝ + ( {p}_{21} + {p}_{22} ) {f}_{2}} ( {X}_{0} - Δ {l}_{1} * sin ∝ ) ] * \frac{1}{{b}_{MAC}} * 100 ( \% ) & ( 9 ) \\ G = {p}_{1} * {f}_{1} * cos ∝ + {f}_{2} ( {p}_{21} + {p}_{22} ) & ( 10 )\end{matrix}$$

### 4.2. Defining the Values of the Parameters

The parameters in equation (9) and (10) are as follows:

L₂₀ is distance from the leading edge of the
b_{MAC} to the main landing gear (constant for the aircraft)
X₀ is the wheel base of an empty, clean aircraft (constant for the aircraft)
∝ is the angle of the nose gear against the vertical axis (constant for the aircraft)
f₁ is the area of the shock absorber's piston of the nose gear (constant for the aircraft)
f₂ is the area of the shock absorber's piston of the main gear (constant for the aircraft)
p₁ is the pressure of the shock absorber into the nose gear (measured by a sensor)
p₂₁, p₂₂ is the pressure of the shock absorber into the left/right main gear (measured by a sensor)
Δl₁ is the movement of the nose gear's shock absorbent piston (measured by a sensor)

The above values, along with the ones incorporated in equation (9), are sent to the aircrafts ACARS to calculate respectively X_{T} and X_{T}.

### 5. Practical Implementation of the Method

The requirements for the implementation are as described below and as shown on FIG. 7:

### Hardware Requirements:

1. Installation of pressure sensors in the shock absorbers of main and nose landing gear.
2. Installation of sensor to determine the movement of the nose gear's shock absorbent piston;

### Software Requirements

1. Availability of ACARS Input/Output (I/O) capacity to receive in real time the information form the sensors and to calculate and display the output information

### REFERENCES

1) Aircraft Weight and Balance Handbook FAA-H-8083 U.S. Department of Transportation, Federal Aviation Administration
2) MASS AND BALANCE IN AIRCRAFT by KADIR BUHARALI

### Patents

1) No US 20100063718 Aircraft center of gravity automatic calculating system
   2) U.S. Pat. No. 6,128,951 Aircraft Weight And Center Of Gravity Indicator
   3) U.S. Pat. No. 6,237,406 B1 Aircraft weight and center of gravity indicator
   4) U.S. Pat. No. 5,548,517 A Aircraft weight and center of gravity indicator
   5) U.S. Pat. No. 5,214,586 Number of patents in Portfolio can not be more than 2000 Aircraft weight and center of gravity indicator
   6) U.S. Pat. No. 3,701,279 A Aircraft weight and center of gravity indicator system

1. Method for automated calculation of the Centre of Gravity and the Weight of the airplane on the ground using formulas
$${\overline{X}}_{T} = [ {L}_{20} - \frac{{p}_{1} * {f}_{1} * cos ∝}{{p}_{1} * {f}_{1} * cos ∝ + ( {p}_{21} + {p}_{22} ) {f}_{2}} ( {X}_{0} - Δ {l}_{1} * sin ∝ ) ] * \frac{1}{{b}_{MAC}} * 100 ( \% )$$
$$G = {p}_{1} * {f}_{1} * cos ∝ + {f}_{2} ( {p}_{21} + {p}_{22} )$$
based on pressure readings from the shock absorbers in the main and nose landing gear, transmitted in real time to the onboard computer in the aircraft cockpit. Therefore the aircraft Centre of gravity and the Weight are calculated while loading, and the human factor is eliminated.
